(19) United States
(12) Patent Application Publication
(10) Pub. No.: US 2023/0040897 A1
(43) Pub. Date: Feb. 9, 2023

(54) SMART SYSTEM FOR OPERATION AND MAINTENANCE OF FIREARMS

(71) Applicant: Sergio Adolfo Nunez, Austin, TX (US)

(72) Inventor: Sergio Adolfo Nunez, Austin, TX (US)

(21) Appl. No.: 17/882,440

(22) Filed: Aug. 5, 2022

Related U.S. Application Data
(63) Continuation of application No. 63/230,686, filed on Aug. 6, 2021.

(51) Int. Cl. F41A 9/62; G01D 5/14; H04W 4/80

(52) U.S. Cl. CPC F41A 9/62; G01D 5/145; H04W 4/80

(57) ABSTRACT

The present invention provides a novel method and system for operating and maintaining firearms. More specifically, the invention disclosed a system and method for monitoring various aspects of a firearm and providing the user information about the status of the firearm in real time by use of smart magazine and optics.

### FIELD OF THE INVENTION

The present invention provides a novel method and system for operating and maintaining firearms. More specifically, the invention disclosed a system and method for monitoring various aspects of a firearm and providing the user information about the status of the firearm in real time.

### BACKGROUND OF THE INVENTION

In traditional firearms, there is no mechanism available to the user except manually monitoring the status of the firearm, such as how many bullets are available in a magazine, if the barrel is overheating, whether the firearm is loaded or not, etc. Furthermore, there are no easy mechanisms to retrieve the information while the firearm is being used except to stop while using the firearm and check for the necessary information.

The same is true for similar devices used in sporting activities such as paintball, airsoft shooting, target shooting. There is little support for making the status of the device readily available to the user of the device.

### SUMMARY OF THE INVENTION

Traditionally sights, firearms, and accessories have been designed to be as low tech as possible in order to ensure reliability. Furthermore, often the size of the electronics may not be compatible with the form factor of a firearm.

The novel invention discloses a system and method to monitor various aspects of a firearm real time and provide the relevant data to the user through the use of a heads up display (HUD) style system using an organic light emitting diode (OLED) technology while the user is using the firearm.

Various embodiments of the invention may provide support for digital counting of ammunition, operational data being displayed on an optic display, customization of optic reticle, and integration of various sensors into a firearm to assist with operation and maintenance of the firearm.

In the embodiments discussed in present application, the Smart Firearm System collects information about the current, or ongoing state of a firearm and may make the information available through the use of the Bluetooth low energy (“BLE”) communication protocol. In certain embodiment, this information may then be transmitted and processed by other peripherals connected through a wireless interface and where the peripherals may use this information for further processing and uses.

The present application discusses the invention in light of a specific firearm, but as would be obvious to a person skilled in the art, the invention may be adapted to any firearm or shooting device, e.g. a Paintball gun or an Airsoft pistol, etc.

The system disclosed by the present application comprises a smart sight which comprises a microcontroller controlled display which collects broadcasted wireless BLE data and displays it to the user of the firearm via a head's up display, using an OLED display mounted on the firearm. In certain embodiments the information may be provided to another person monitoring the activity. In yet other embodiments the information may be made available locally on a display mounted on the magazine itself. Certain embodiments may provide the information as percent of ammunition left and in other embodiments the information may be provided in terms of amount of ammo left in the magazine.

### DESCRIPTION OF FIGURES

Different embodiments will now be described in detail with reference to the drawings, in which:

FIG. 1 illustrates a sight module adapted to mount a heads up display in accordance with an embodiment of the present invention;

FIG. 2 illustrates a sight module adapted to mount a heads up display further comprising a housing to house the electronic circuit board in accordance with an embodiment of the present invention;

FIG. 3 illustrates a profile view of a magazine for a firearm in an embodiment of the present invention;

FIG. 4 illustrates another profile view of the magazine for the firearm in an embodiment of the present invention;

FIG. 5 illustrates a internal view of the spine of the magazine showing the placement of magnets along the spine of the magazine in accordance with an embodiment of the invention;

FIG. 6 illustrates a profile view of the follower assembly in a magazine for a firearm in an embodiment of the present invention;

FIG. 7 illustrates a different profile view of the follower assembly in a magazine for a firearm in an embodiment of the present invention;

FIG. 8 illustrates a top view of the base plate of the magazine in accordance with an embodiment of the invention;

FIG. 9 illustrates an attachable assembly to go on the base plate which would be connected to the follower in the magazine by a spring in accordance with an embodiment of the invention;

FIG. 10 illustrates a composite view of a smart magazine in accordance with an embodiment of the invention;

FIG. 11 illustrates a profile view of a standard magazine for a firearm;

FIG. 12 illustrates a different profile view of the magazine for a firearm in another embodiment of the present invention with mechanism for mounting attachments to the magazine;

FIG. 13 illustrates a profile view of the magazine for a firearm in an embodiment of the present invention with a printed circuit board mounted to the magazine;

FIG. 14 illustrates an internal view of the spine of the magazine showing the placement of metal contacts in accordance with an embodiment of the invention;

FIG. 15 illustrates an external view of the spine of the magazine showing the placement of metal contacts and notches for connecting wires in accordance with an embodiment of the invention;

FIG. 16 illustrates a profile view of a follower assembly in a magazine for a firearm in an embodiment of the present invention;

FIG. 17 illustrates a different profile view of the follower assembly in a magazine for a firearm in an embodiment of the present invention depicting the placement of contact pins;

FIG. 18 illustrates a view of the follower assembly inside a magazine for a firearm along depicting the contact mechanism for the pins with the mounted metal elements in the magazine in an embodiment of the present invention;

FIG. 19 illustrates another profile view of the magazine for a firearm showing the various elements of the invention inside the magazine in an embodiment of the present invention;

### DETAILED DESCRIPTION OF THE INVENTION

The disclosed system and methods incorporate various peripheral modules interconnected with each other to provide real time status and monitoring of firearms and similar other devices for their operation and maintenance. The invention can be better understood through illustration of a some of the key concepts and peripheral modules supported by the system.

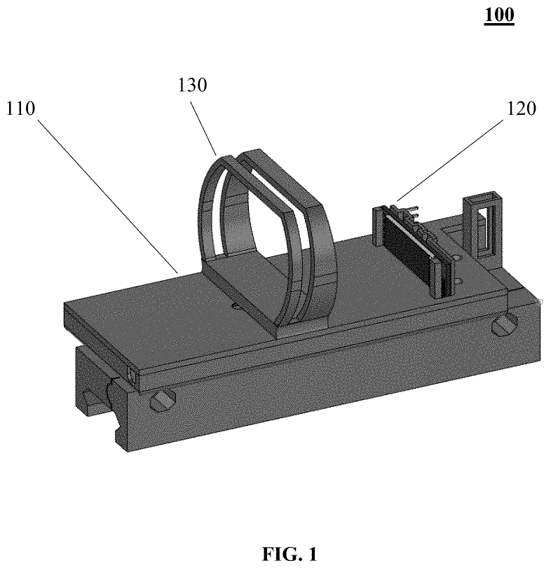

FIG. 1 illustrates a sight module 100 adapted to mount a heads up display in accordance with an embodiment of the present invention using a mounting plate 110. In certain embodiments, the system may include a microcontroller controlled, “Smart Sight” module capable of collecting broadcasted wireless BLE data and displays it via a Head's Up Display (“HUD”) style system 120, using an OLED (“Organic Light Emitting Diode”) display. The displayed data may be viewed by the operator of the firearm in real time as the operator is aiming through the sight 130.

In the embodiment illustrated in FIG. 1, the sight 130 is mounted on the firearm itself and may be adjusted in the same fashion as a traditional Red Dot Sight or Reflex sight, thus enabling normal aiming, firing, and standard operation of the firearm.

The HUD module 120 may receive information in real time from a microcontroller controlled smart magazine or clip through a wireless pairing using any of a number of wireless protocols such as Bluetooth Low Energy protocol or a variation of some Wi-Fi radio transmitter-receiver pair specifically tailored for this application.

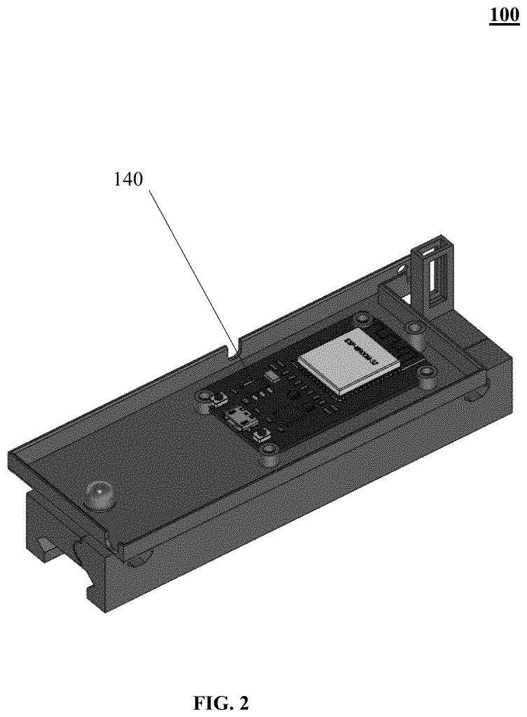

FIG. 2 illustrates an embodiment of the sight module 100 where the required electronics module 140 is embedded in the sight module 100 itself. In embodiments, the included electronics may provide support for the reception of the Bluetooth transmitted data, processing of the data for consumption by the user in the preferred formats as well as support to display the data on the HUD mounted on the sight. In some embodiments the included electronics module may also provide additional support for the user to customize the reticle into a shape or design of their choosing or choose from a preset number of customized choices setup by the user. In other embodiments the electronic control module may receive additional data related to other aspects of the firearm, such as temperature, lubrication status, presence of moisture, etc. through use of various sensors in the firearm in communication with a control module.

The electronics module in the system may receive data from multiple sensors/peripherals communicating and sending data wirelessly. Traditional firearm sights with optics only display a single LED dot (Reflex/Red Dot sights), or a projection of a static image onto the optic display (Holographic Sights). Some of the more advanced sights such as thermal and infrared optics achieve the functionality by adding existing imaging technology on to the sight mounted onto a firearm. The present invention provides information that is not available to a user through the use of traditional systems, and may use the optic display 120 depicted in FIG. 1 as a delivery mechanism for this additional information.

The disclosed invention may be practiced in various embodiments where the HUD may be implemented by using a different type of display technology than OLED, LCD or LED displays as described in the exemplary embodiment, where such displays may use alternative display technologies available today or that may be developed in the future.

It will be apparent that if instead of using a firearm optic, a side display panel were to be mounted on the magazine itself to provide this information to the user, this would still be in the realm of this invention because the invention is not limited to the sight itself and enables the digital display of operational data in general through various mechanisms. Similarly, providing the operational data to another person not directly using the firearm may be another embodiment of the invention to allow for monitoring of the firearm use.

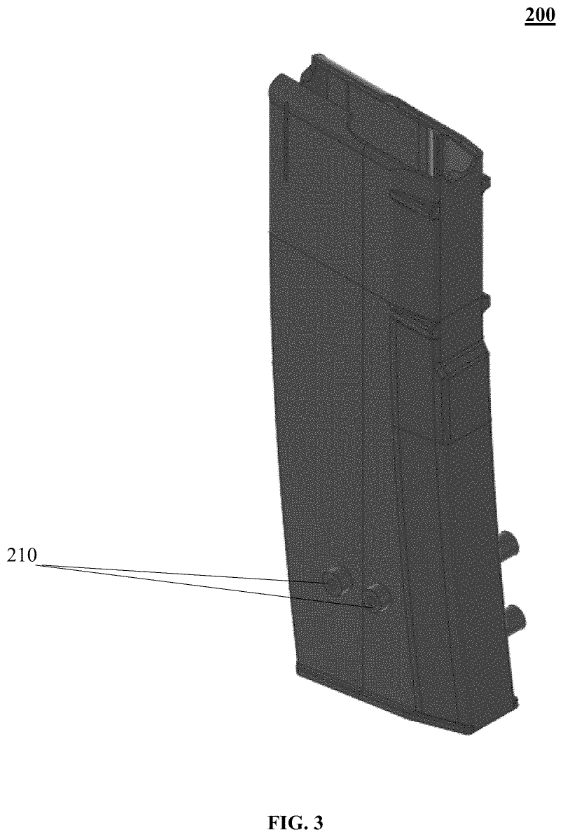

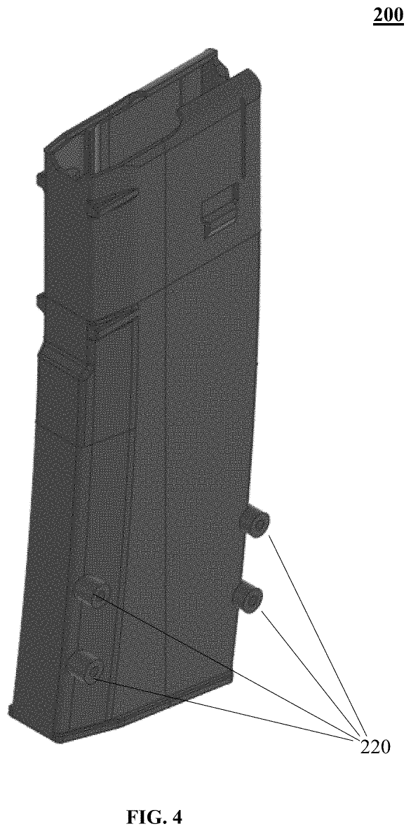

The disclosed system for monitoring a firearm for its operation and maintenance may also include a smart magazine. Referring to FIG. 3 and FIG. 4, which illustrate two side profile views of a firearm smart magazine as per an embodiment. Certain embodiments may provide for mounting mechanism to mount a battery to power the electronics module on the magazine as well as mounting mechanism to also mount an electronic module to process sensor data and monitor the status of the magazine. The referred figures illustrate a mounting mechanism with two mounts 210 to mount the battery powering the electronic module and a mounting mechanism with four mounts 220 to mount the electronic module.

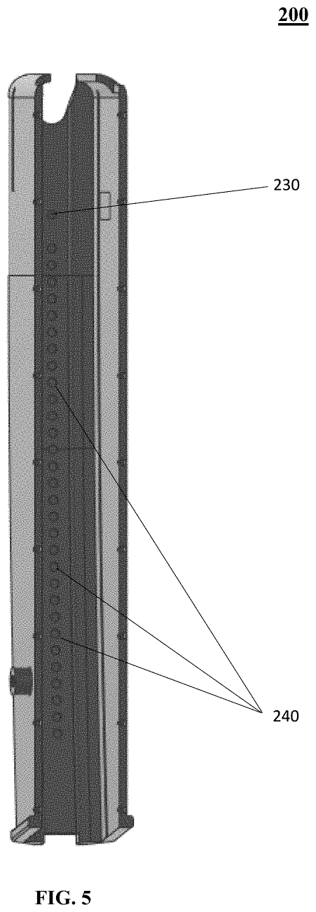

FIG. 5 illustrates the internal view of the spine of the magazine, where the magazine has support for mounting certain sensors 230 and 240 to be able to monitor the number of rounds in the magazine.

In some embodiments, the smart magazine may continuously broadcast over BLE information regarding the current amount of ammunition remaining inside the magazine. In certain embodiments, there may be an optional display that may be embedded into the magazine to digitally display the state of the magazine as well as the current ammunition count.

At the start of the process, the magazine may be in an “empty” state waiting for the user to load the magazine. In some embodiments, once loaded, the user may need to press a button to signal it has been filled to capacity. Once this button is pressed the magazine may exit the “empty” state and may display the magazine specific maximum magazine capacity which may vary for various capacity magazines such as magazines with 30 rounds, 20 rounds, or 10 rounds capacity.

In other embodiments automatic triggering mechanism may be used to signal that magazine capacity is reached. In yet other embodiments, the trigger points for loading a battery or notifying need for new ammunition may be preset at capacity or may be allowed to be set by the user to different numbers than the capacity of the magazine.

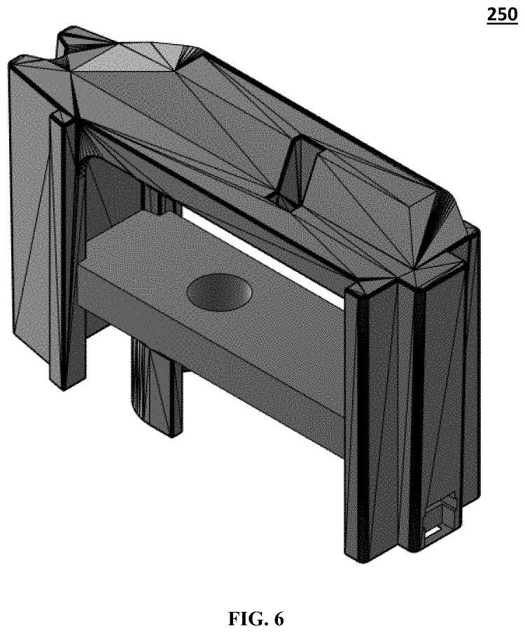

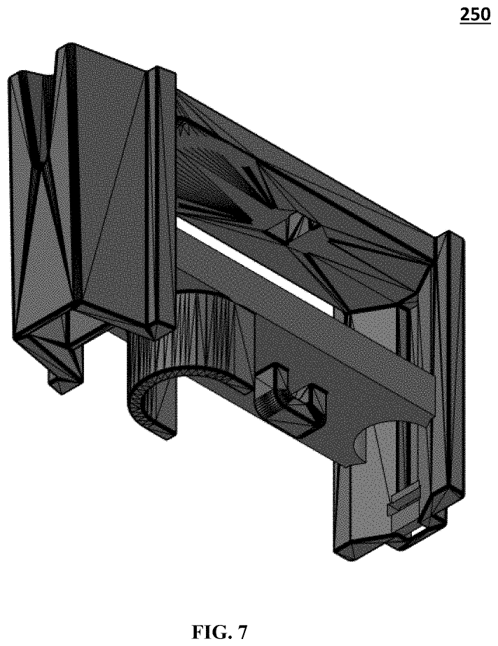

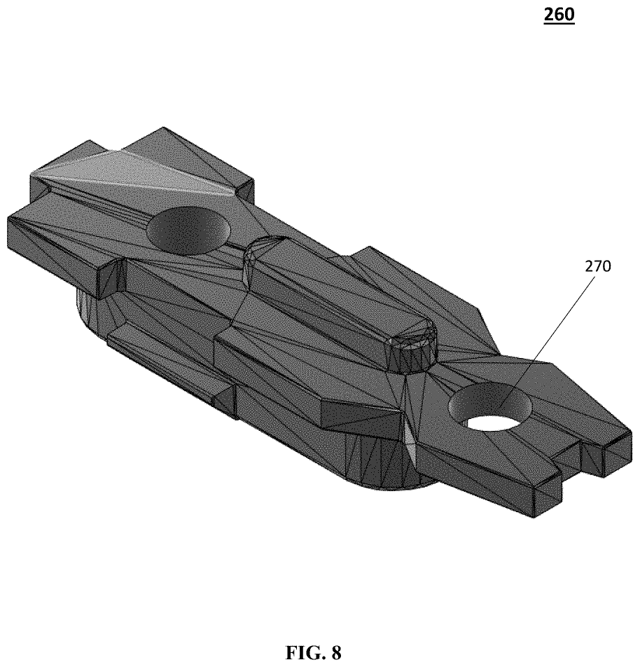

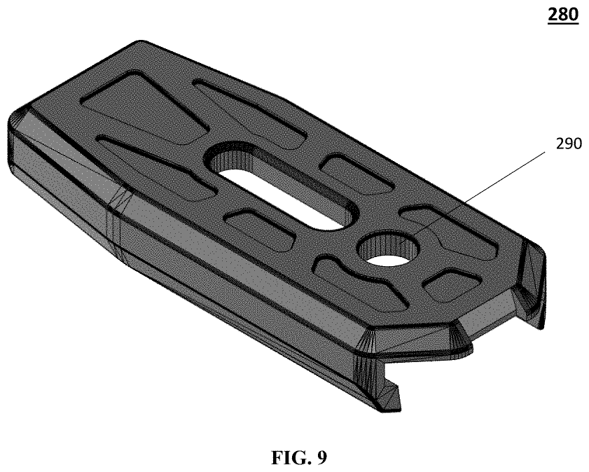

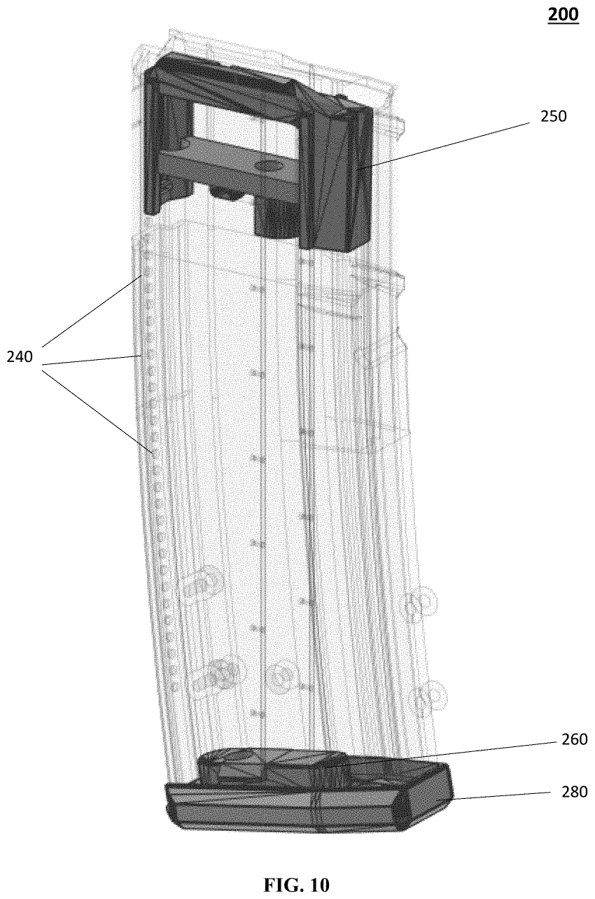

The exemplary embodiment illustrated in FIG. 5, to track the ammunition quantity comprises a column of magnets 240 with magnets with their south pole oriented inward and a single magnet 230 with its north pole oriented inwards at the top of the magazine to signal an empty magazine. These magnets are embedded into the spine of the magazine body as depicted in FIG. 5 that align with specific positions based on the location of the magazine follower. When the magazine is empty the follower 250 illustrated in two different profile views in FIG. 6 and FIG. 7 is held at the top of the magazine using a spring, however when the magazine is full the spring is compressed and the follower sits at the bottom of the magazine on top of the base assembly module 260 illustrated in FIG. 8 which sits on top of the base 280 of the magazine illustrated in FIG. 9. In the illustrated embodiment, the magazine follower is embedded with a Hall Effect Sensor that communicates if the presence of a magnet is detected. All the modules of the magazine are illustrated in the composite image of magazine 200 in FIG. 10.

A Hall Effect Sensor is a type of sensor which detects the presence and magnitude of a magnetic field using the Hall Effect. The output voltage of a Hall sensor is directly proportional to the strength of the magnetic field. Each magnet may be spaced apart according to the dimensions of the intended projectile being used. When a bullet or projectile leaves the magazine the follower will be displaced vertically up by a distance equal to the height of the projectile. This will cause the Hall Effect sensor in the follower to pass by one of the embedded magnets.

The Hall effect sensor will generate a positive or negative voltage depending upon detecting the north pole or a south pole respectively. When the sensor detects the magnet 240 with the north pole facing inwards, that voltage may be used by the electronics module to determine the empty state of the magazine. As the sensor moves through each magnet 240 with its south pole oriented towards the sensor, the generated negative voltage may be used by the electronics module to adjust the count up and down depending upon whether the magazine is being loaded or the firearm is being used with the follower moving up towards the empty state.

This may be used to decrease the count of available ammunition by one every time a bullet is removed by firing when the firearm is being used. When the magazine follower detects the north pole magnet 230 it returns to the “empty” state and if a display is available, may prompt the user to refill the magazine.

In other embodiments, the magnets 230 and 240 embedded in the spine of the smart magazine may be replaced with metals that respond to magnets and use a sensor which is biased against a permanent magnet to determine the crossing over the embedded metal pieces. Yet other embodiments may implement the ammunition counting mechanism by using potentiometers or linear ribbon controllers to determine the position of the follower to calculate the ammunition count remaining and transmit the information to the microcontroller for notification to the user.

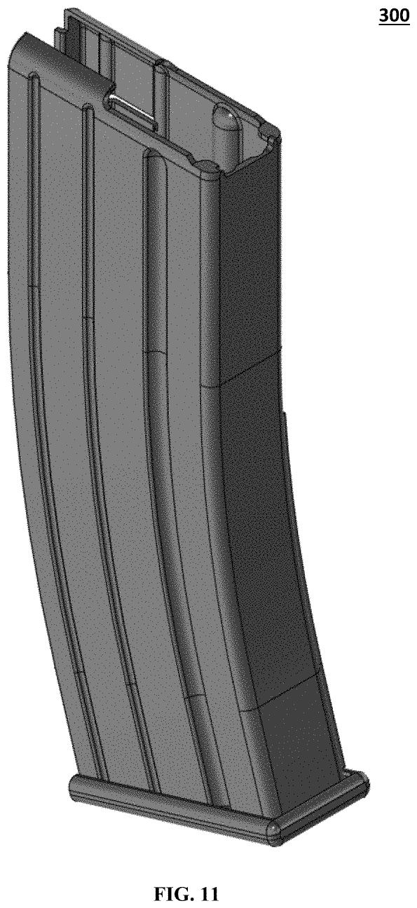

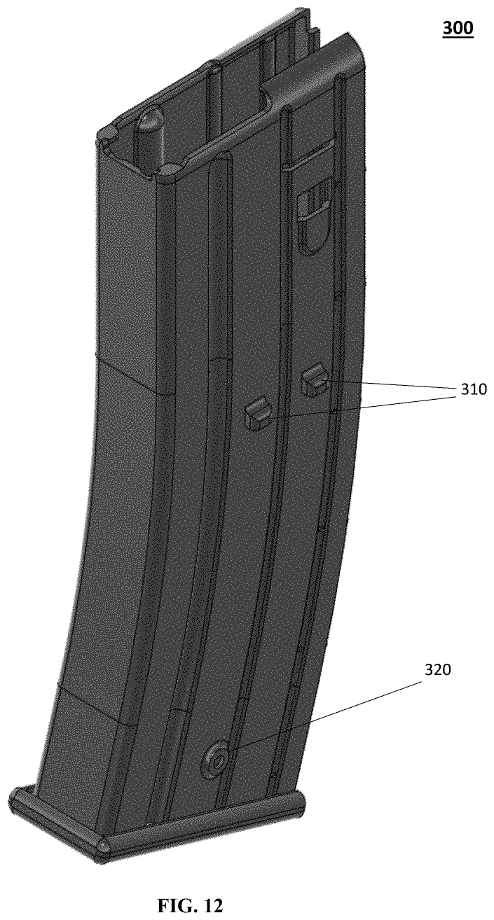

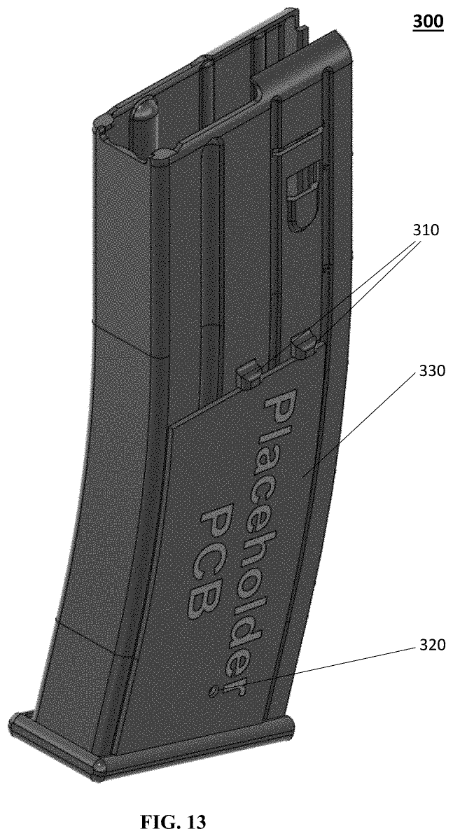

FIG. 11 illustrates a profile view of a standard magazine for a firearm. FIG. 12 illustrates a profile view of a modified magazine 300 in an embodiment of the present invention which utilizes metal contacts instead of magnets in the spine of the magazine. FIG. 12 further illustrates placement of mounting brackets 310 and a screw hole 320 to mount an electronic module directly to the magazine. FIG. 13 illustrates the magazine 300 with an electronic control board 330 mounted to the magazine using the mounting brackets 310 and the screw hole 320.

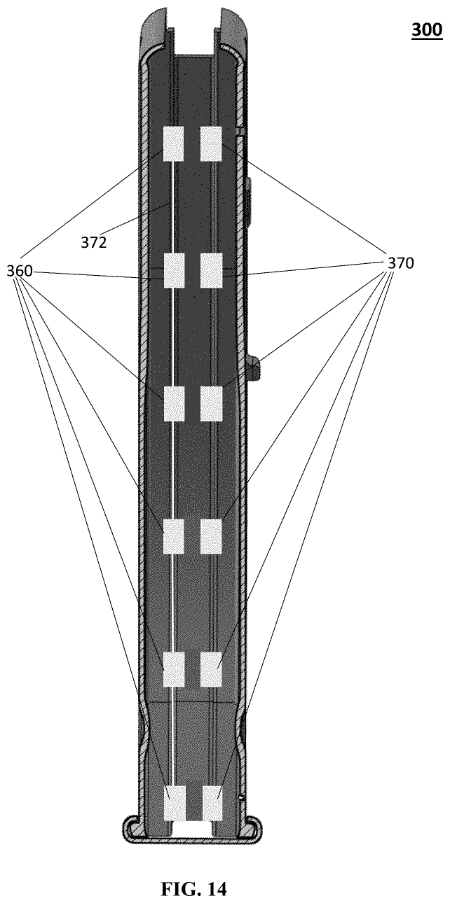

FIG. 14 is an exposed internal view of the spine of the magazine 300 illustrating the mechanism to include the metal contacts in an exemplary embodiment. A series of metal contacts 360 are mounted on one side of the spine interconnected to each other via a conductive connector 372 which is connected to a control board for monitoring the magazine. Another set of metal contacts 370 are mounted on the other side of the spine and each of them is individually connected to an input on the electronics module.

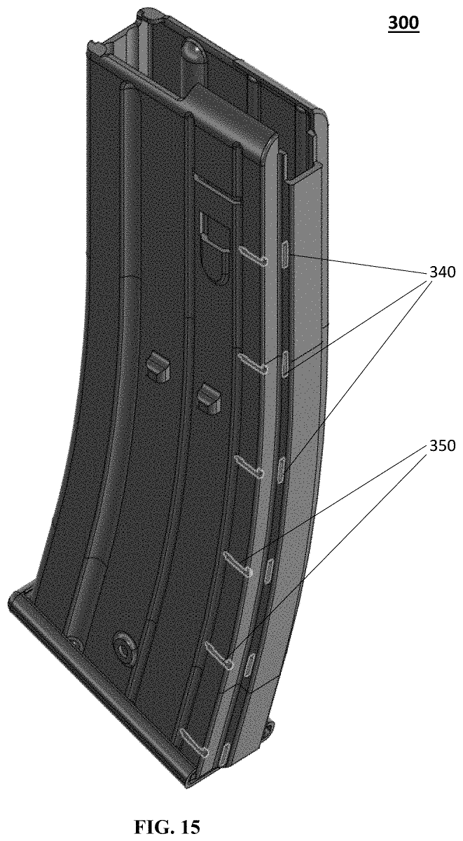

FIG. 15 is an external view of the magazine 300 illustrating the connectivity mechanism for the metal contacts 360 through the slits 340 on the spine of the magazine which may be used to connect the contacts by threading conductive wires through a series of slits 350 on the side of the magazine and fed to the electronics module mounted on the side of the magazine as illustrated in FIG. 13.

As would be apparent to a person skilled in the arts, in other embodiments, the system may use other conductive materials instead of metal for the contact points. In embodiments, connectivity may be achieved through use of etched conductors in the magazine itself instead of use of conductive wires.

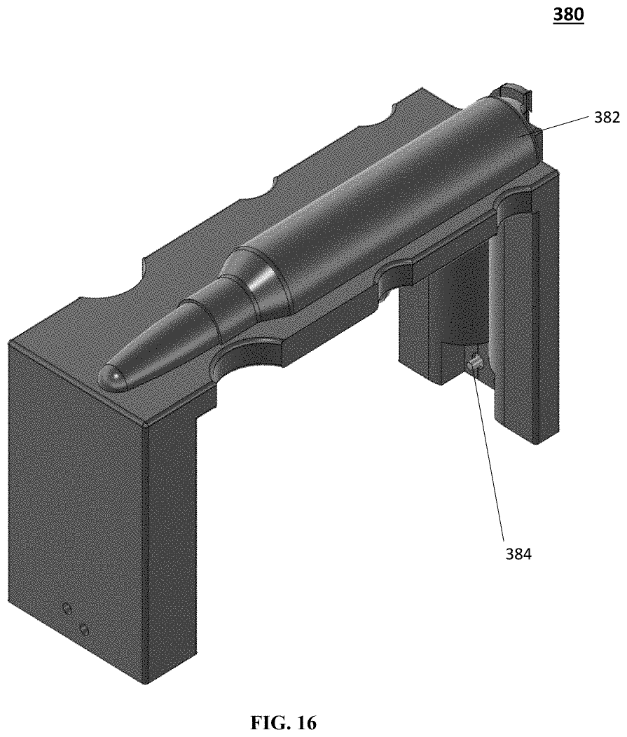

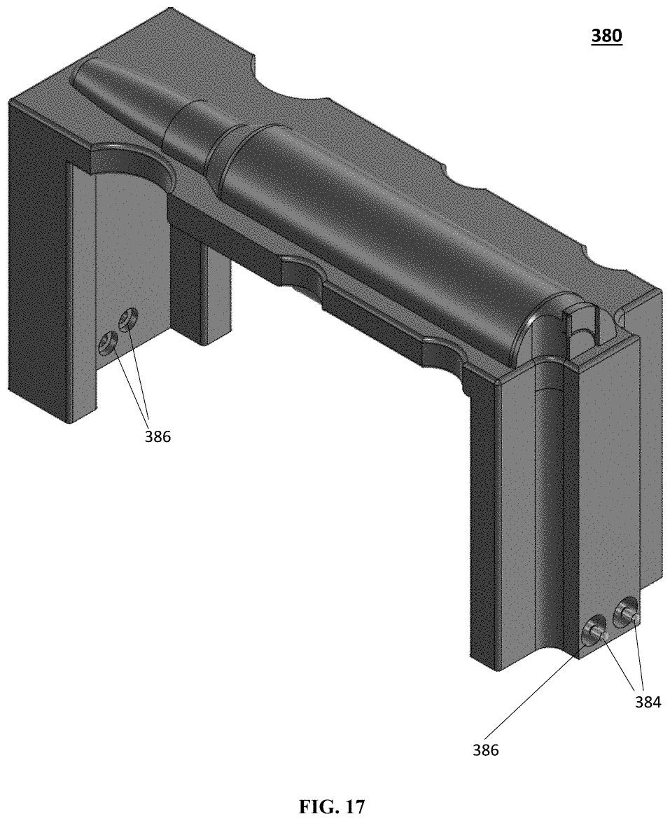

FIG. 16 illustrates a view of the follower 380 which traverses down in the magazine as the bullets are loaded and moves up every time a bullet 382 is fired and the bullet shell ejected from the magazine. FIG. 16 also illustrates the inside view of one of the pins 384 of the pair of pins mounted inside the follower 380 comprises which are used to connect two adjacent metal contacts 360 and 370 as depicted in FIG. 14 as the follower moves up and down the magazine. FIG. 17 further illustrates in a different profile view the pair of pins 384 that touch the spine of the magazine as the follower 380 moves in the magazine. The pins 384 may be mounted through the pin placement holes 386 which may be provided on either of the spines of the magazine in conjunction with the metal contacts on that same spine. The pair of pins 384 on the follower 380 are electrically connected to each other. In different embodiments, the contacts may be placed adjacent to each other at same level or may be staggered in height to accommodate placement along with staggering of the contact pins 384 in the same manner.

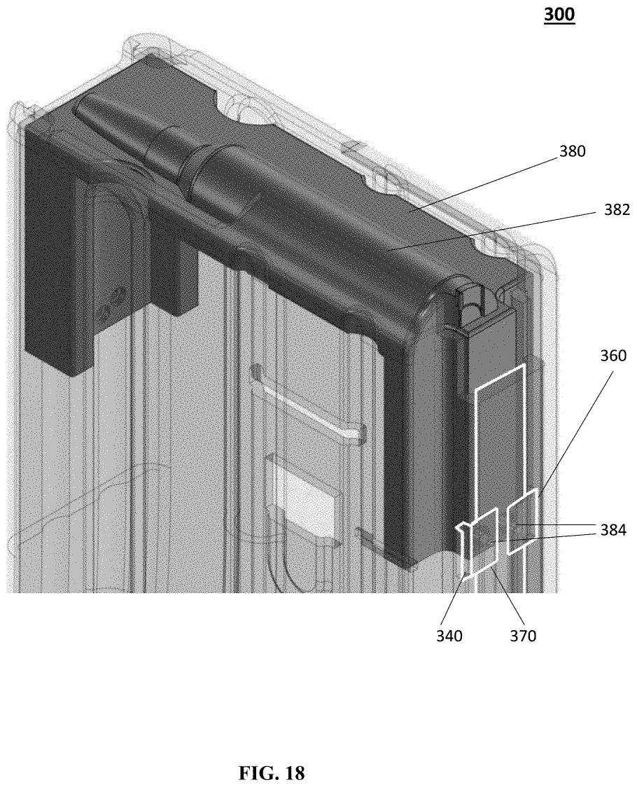

Referring to FIG. 18, the mounted contact pins 384 connect the contacts 360 and 370 as a result completing that circuit and the electronics module may use the information provided through the current flowing or the voltage generated through the completed circuit to determine the position of the follower 380 in the magazine 300 to determine the number of bullets remaining or fired from the magazine.

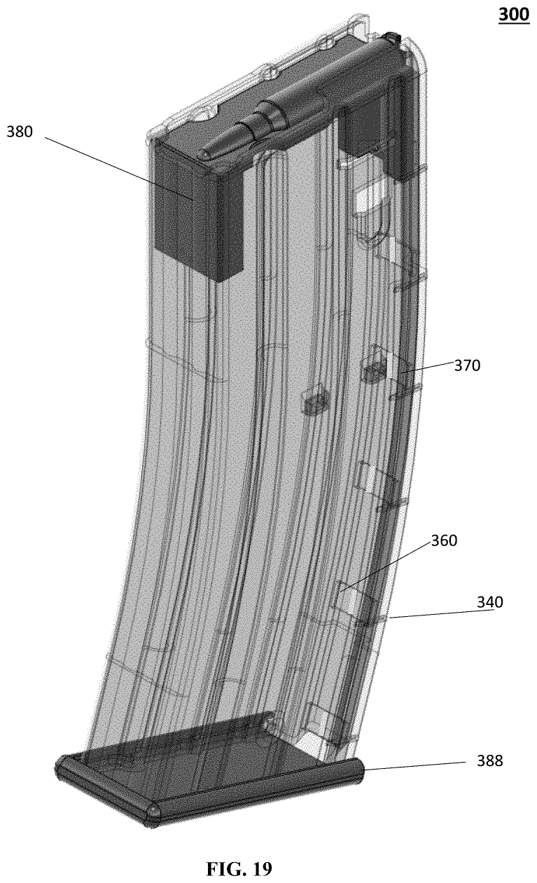

FIG. 19 is a composite view of the magazine 300 illustrating the base plate 388 along with the follower 380, the slits 340 and the metal contacts 360 and 370 inside the spine of the magazine 300.

The following describes the basic functionality of the smart magazine 300 as an embodiment of the invention. The metal contacts 360 which are ganged together through the connector 372 as illustrated in FIG. 14 may be fed a small voltage by the electronic module through the connector 372. Each of the metal contacts 370 may be connected individually to an independent input being monitored by a microcontroller in the electronics module for voltage and will have no voltage unless the electrical connection is completed by shorting the adjacent contacts 360 and 370 by the contact pins 384 in the follower 380 as the follower reached a specific pair of contacts 360 and 370. The completed circuit may provide a positive or negative voltage at the monitored input in the electronics module for that particular metal contact 370. The presence of voltage at a specific input may be used by the microcontroller in the electronics module to determine the remaining bullets in the magazine 300.

In other embodiments, each metal contact 370 may use resistive loads to implement different voltages at a single input at the electronics module monitoring the voltage to determine the position of the follower to calculate the ammunition count remaining and transmit the information to the microcontroller for notification to the user.

In certain embodiments, the contacts 360 and 370 may be placed to match exactly the width of each bullet to be able to determine the addition or subtraction of each bullet. In other embodiments, the metal contacts 360 and 370 may be placed at different intervals to allow for determining the magazine status at a coarser level such as 100% full, 75% full, 50% full and empty.

This information may be used by the electronics module to display the status of the magazine to the user by means of a local display mounted on the magazine itself, through a separate display such as the heads up display discussed earlier or another display mechanism, such displays being connected to the electronics module through a wired or wireless interface.

At the start of the process, the magazine may be in an “empty” state waiting for the user to load the magazine. Referring the exemplary embodiment of magazine 300, when the magazine is empty the follower 380 illustrated in two different profile views in FIG. 16 and FIG. 17 is held at the top of the magazine using a spring, however when the magazine is full the spring is compressed and the follower sits at the bottom of the magazine on top of the base assembly 388 illustrated in FIG. 19. In this position, the contact pins 384 will complete a circuit through the metal contacts 360 and 370 placed at the bottom of the magazine resulting in that input to have a voltage for the electronics module to measure the presence of voltage. As a round of ammunition is fired and leaves the magazine 300, the follower 380 will move up by the width of the ammunition round and complete the circuit with the next set of metal contacts 360 and 370 in an embodiment where the metal contacts are placed at intervals equal to the width of the ammunition round. The electronics module may either detect the presence of a voltage at that specific input or detect a change in voltage for an embodiment that implements a scheme that provides different voltages at each pair of metal contacts through the use of resistive or other types of voltage dividing circuitry and use that information to determine the number of rounds remaining in the magazine.

In certain embodiments, the magazine may be equipped only with the sensors and a transmitter to transmit the data through a wired or wireless channel to a microcontroller which may be part of an electronics module embedded in another part of the firearm, such as the sight or the stock assembly.

It will be apparent that in other embodiments, different types of mechanisms may be used for determining the number of bullets in the magazine by using completely different types of sensors and related mechanisms for determining the travel of the follower inside the magazine instead of using magnets, metal or other conductive material contacts.

Embodiments may use the smart magazine to provide a clear and definitive count of how much ammunition is left in the magazine on a HUD providing a vast improvement over the currently available mechanism of manually reviewing a window on the magazine to see the current position of the follower and determine from that how much ammunition is left in the magazine.

In other embodiments, the electronic control module may include support for other peripherals, such as support to monitor barrel temperature by using thermistors and receiving that data to determine the temperature and notify the user if the firearm barrel is overheating and similar other peripherals.

Traditional devices are not digital and lacks support for dissemination of firearm specific operational data to the user. In military applications, the operational data provided by the invention may assist in relatively more efficient battlefield operations as a consequence of the system and methods disclosed to keep the user better informed about the status of their weapon. Such improvements may include, but are not limited to: avoiding being caught off guard with an empty magazine, avoiding the firearm performing poorly due to overheating, or any other malfunctions or inefficiencies due to the lack of awareness of the user about their firearm.

Various embodiments of the invention may use different off the shelf microcontrollers such as Arduino, ESP32, Raspberry Pi, etc. or a specific custom microcontroller can be developed as a specific application processor to provide support for the various aspects and features desired in the embodiment. Similarly, various types of display systems may be incorporated in different embodiments of the invention instead of the OLED display, such as LCD or LED displays.

Similarly, the discloses system and methods may be implemented by using various wireless connectivity protocols, currently existing or developed in the future, instead of Bluetooth connectivity.

In some embodiments, the main electronics module may be part of another part of the firearm instead of being housed in the optics sight module, such as the stock of the firearm. In such embodiments, the various aspects of reception of data, processing of date, conversion of the date to a usable format and the actual display of the data may be distributed across multiple modules. In other embodiments the system and methods of the invention may be practiced with wired connectivity instead of the wireless connectivity.

As would be apparent, the concepts, methods and systems presented are applicable to use of any other types of sensors capable of monitoring other aspects of the device to monitor and manage the firearm components and the firearm as a whole. In certain embodiments, there may be multiple sensor/transmitter modules communicating with a central electronics module with a microcontroller to receive and process the data from such multiple sensor modules and use an integrated or separate display module to present the data one at a time or simultaneously for the user to view and act upon. In certain embodiments, the user may have the capability to turn on and off the sub systems monitoring the different parts of the firearm.

It will also be apparent that the various modules of the invention disclosed herein may be implemented in an integrated module or distributed across devices and modules providing support for specific feature. It will also be apparent that the sensors used to implement the system may vary from embodiment to embodiment practicing the invention. In certain embodiments the display may be substituted for an existing display, such as a mobile phone. Yet other embodiments may provide support for mounting and interfacing with existing displays such as those of smart phones. Yet other embodiments may utilize camera functions of such mobile phones to implement smart sights.

We claim:

1. A system to provide firearm status in real time, said system comprising:
a magazine configured with a sensor to determine an amount of ammunition remaining in the magazine;
an electronic control module configured to receive information from the sensor in the magazine;
a display unit in communication with the electronic control module.

2. The system of claim 1, wherein the magazine further comprises a follower assembly configured to monitor the sensor.

3. The system of claim 1, wherein the follower assembly uses a Hall Effect Sensor and the sensor in the magazine is a magnet.

4. The system of claim 1, wherein the sensor in the magazine uses a pair of electrical conductive material and the follower uses a pair of electrically interconnected pins to complete the electrical connection in the sensor.

5. The system of claim 1, wherein the sensor is implemented by using as many sensors as the holding capacity of the magazine.

6. The system of claim 1, wherein the sensor is implemented using a resistive network circuit.

7. The system of claim 1, wherein the electronic control module is mounted on the side of the magazine.

8. The system of claim 1, wherein the electronic control module is housed inside a sight mounted on the firearm.

9. The system of claim 1, wherein the display unit in communication with the electronic control module uses a Bluetooth Low Power protocol for communication with the electronic control module.

10. The system of claim 1, wherein the display unit in communication with the electronic control module uses a wired connection for communication with the electronic control module.

11. A method to display firearm status in real time, said method comprising the steps of:
receiving sensor data from a sensor in a magazine by an electronic control module;
processing received data from the sensor by the electronic control module;
determining a quantity of ammunition remaining in the magazine;
sending the resulting data to a display unit;
displaying the quantity of remaining ammunition on a display.

12. The method of claim 11, wherein the step of receiving the sensor data utilizes magnetic sensor and Hall Effect.

13. The method of claim 11, wherein the step of receiving sensor data utilizes an electrical circuit.

14. The method of claim 11, wherein the step of receiving the sensor data utilizes an electrical circuit with a resistive network.

15. The method of claim 11, wherein the step of displaying the quantity of remaining ammunition uses a heads-up display.

16. The method of claim 11, wherein the step of displaying the quantity of remaining ammunition uses a local display mounted on the magazine.

17. The method of claim 11, wherein the step of processing received data from the sensor by the electronic control module is performed by an electronic control module mounted on the magazine.

18. The method of claim 11, wherein the step of processing received data from the sensor by the electronic control module is performed by an electronic control module mounted on the firearm.

19. The method of claim 11, wherein the step of processing received data from the sensor by the electronic control module is performed by an electronic control module located away from the firearm but connected to the firearm through a wireless connection.
